(19) United States
(12) Patent Application Publication
(10) Pub. No.: US 2014/0197645 A1
(43) Pub. Date: Jul. 17, 2014

(54) HANDLE DEVICE AND LOCK IMPLEMENTING THE SAME

(71) Applicant: TAIWAN FU HSING INDUSTRIAL CO., LTD., Kaohsiung City (TW)

(72) Inventors: Shih-Min Lu, Kaohsiung City (TW); Fu-Chih Huang, Kaohsiung City (TW); Tsung-Yu Li, Kaohsiung City (TW)

(73) Assignee: TAIWAN FU HSING INDUSTRIAL CO., LTD., Kaohsiung City (TW)

(21) Appl. No.: 13/802,805

(22) Filed: Mar. 14, 2013

(30) Foreign Application Priority Data
Jan. 17, 2013 (TW) 102101776

(51) Int. Cl. E05C 1/16

(52) U.S. Cl. CPC E05C 1/16
USPC 292/143; 16/412

(57) ABSTRACT

A handle device includes a pivoting portion and a handle body. The pivoting portion includes a surrounding wall formed along a longitudinal axis, and the surrounding wall has a top surface. The handle body comprises an extending portion which protrudes from the pivoting portion along a radial direction perpendicular to the longitudinal axis and is apart from the top surface of the surrounding wall by a gap.

### BACKGROUND OF THE INVENTION

1. Field of the Invention

The present invention relates to a handle device and a lock implementing the same, and more particularly, to a handle device capable of meeting fire prevention regulations and saving costs and a lock implementing the same.

2. Description of the Prior Art

Conventionally, a lock includes a latch installed on a door. A latch head of the latch is connected to a handle device by a latch driving member, and the handle device is used for driving the latch driving member, so that the latch driving member can activate the latch head to stretch out of the door or retract inside the door. In such a manner, when the latch head stretches out of the door, the latch head latches the corresponding wall, so as to lock the door on the wall. When the latch head retracts inside the door, the latch head separates from the corresponding wall, so as to unlock the door from the wall.

The conventional handle device includes a handle body and a pivoting portion connected to the handle body. A latch assembly is installed inside the pivoting portion. According to fire prevention regulations, a gap needs to be reserved between the handle body and the door. However, the fire prevention regulations differ from nation to nation, it results in design change for the handle body, the pivoting portion and the latch assembly installed inside the pivoting portion in accordance with the various fire prevention regulations. As a result, it causes a great increase in costs and does not facilitate to market.

### SUMMARY OF THE INVENTION

The present invention provides a handle device capable of meeting fire prevention regulations and saving costs and a lock implementing the same for solving above drawbacks.

According to an embodiment of the present invention, a handle device includes a pivoting portion and a handle body. The pivoting portion includes a surrounding wall formed along a longitudinal axis, and the surrounding wall has atop surface. The handle body protrudes from the pivoting portion along a radial direction perpendicular to the longitudinal axis. The handle body is not connected to the top surface of the surrounding wall and apart from the top surface of the surrounding wall by a gap.

According to another embodiment of the present invention, a lock includes a latch sleeve, a latch head and a handle device. The latch head is disposed inside the latch sleeve in a retractable manner. The handle device is for retracting the latch head inside the latch sleeve and includes a pivoting portion and a handle body. The pivoting portion includes a surrounding wall formed along a longitudinal axis, and the surrounding wall has a top surface. The handle body protrudes from the pivoting portion along a radial direction perpendicular to the longitudinal axis. The handle body is not connected to the top surface of the surrounding wall and apart from the top surface of the surrounding wall by a gap.

In summary, the present invention can further change a distance between the extended portion of the handle body and the door by adjusting the gap, so as to satisfy the fire prevention regulations from nation to nation and further to increase flexibility in use. In addition, since the size of the pivoting portion does not change, there is no need to do design change on the latch assembly disposed inside the pivoting portion for saving costs. In other words, the structural design of the extended portion of the handle body, the pivoting portion and the gap of the present invention can not only satisfy the fire prevention regulations from nation to nation but also save costs.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a lock according to an embodiment of the present invention.

FIG. 2 is an exploded diagram of the lock according to the embodiment of the present invention.

FIG. 3 is a sectional diagram of the lock according to the embodiment of the present invention.

FIG. 4 is a sectional diagram of a lock according to another embodiment of the present invention.

FIG. 5 is a diagram of the lock in another status according to the embodiment of the present invention.

FIG. 6 is a sectional diagram of a lock according to another embodiment of the present invention.

FIG. 7 is a diagram of a handle device according to the embodiment of the present invention.

FIG. 8 is a diagram of the lock according to the embodiment of the present invention.

FIG. 9 is a diagram of a handle device according to another embodiment of the present invention.

### DETAILED DESCRIPTION

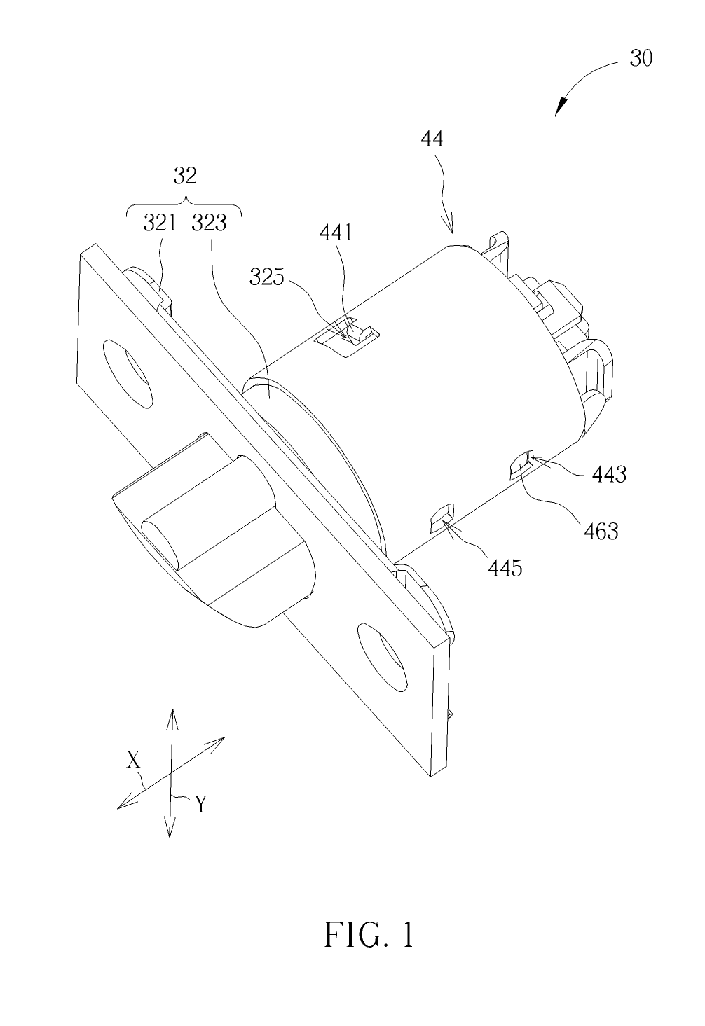

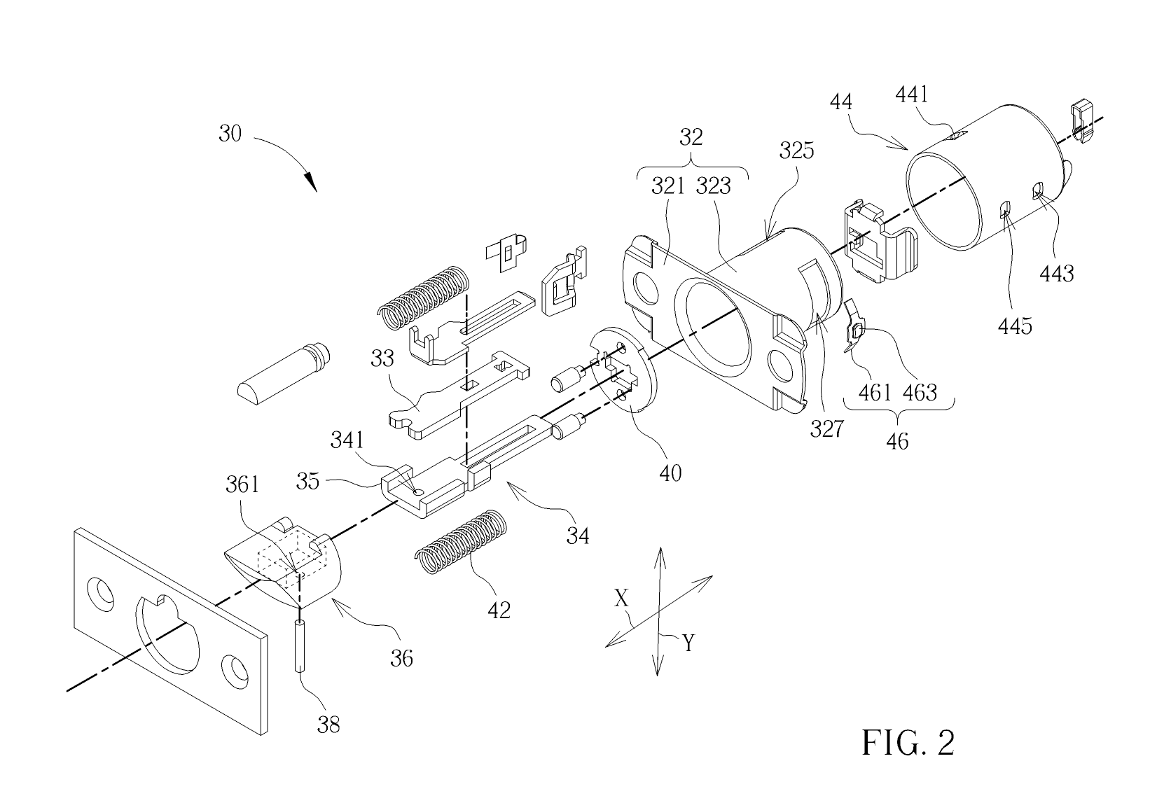

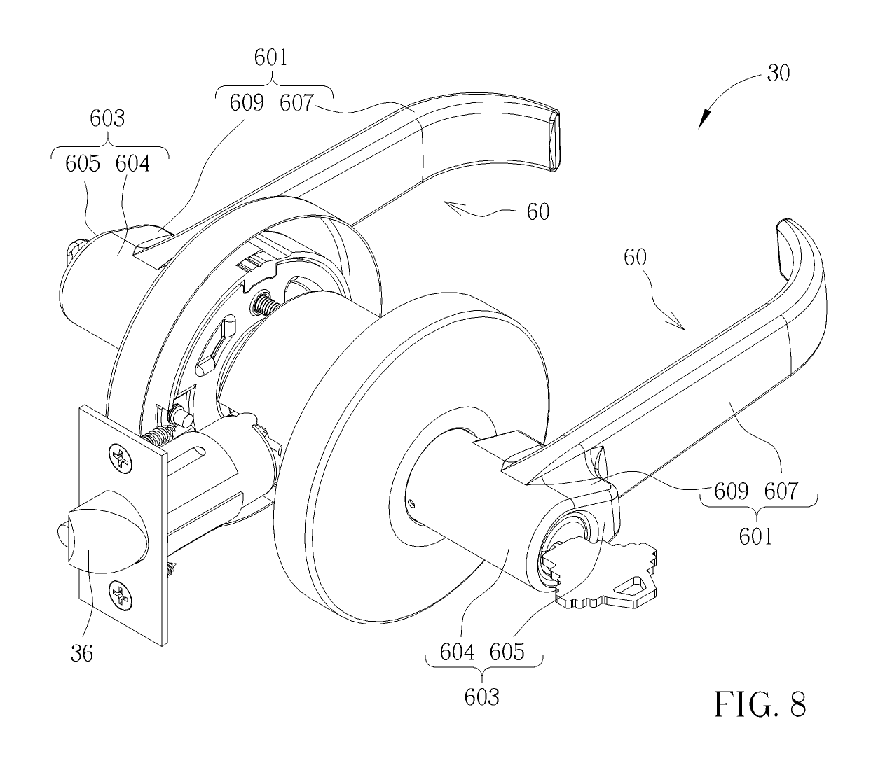

Please refer to FIG. 1, FIG. 2 and FIG. 8. FIG. 1 and FIG. 8 are diagrams of a lock 30 according to an embodiment of the present invention. FIG. 2 is an exploded diagram of the lock 30 according to the embodiment of the present invention. As shown in FIG. 1, FIG. 2 and FIG. 8, the lock 30 includes a latch sleeve 32, a latch driving member 34, a latch head 36 and a handle device 60. The latch sleeve 32 is fixed on a door, not shown in figures. A first fixing structure 341 is formed on an end of the latch driving member 34. The latch head 36 is connected to the end of the latch driving member 34, and the handle device 60 is used for retracting the latch head 36 inside the latch sleeve 32.

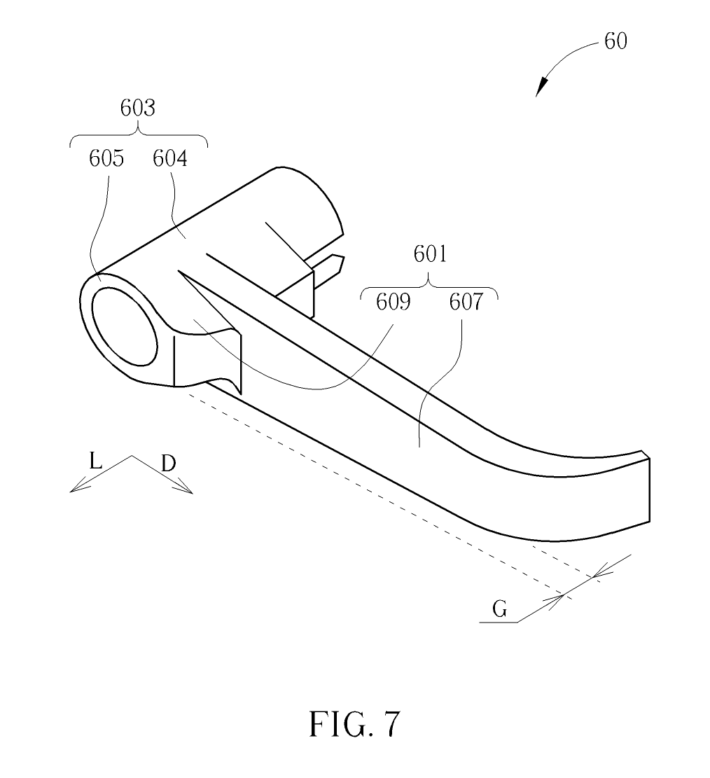

Please refer to FIG. 1, FIG. 2, FIG. 7 and FIG. 8. FIG. 7 is a diagram of the handle device 60 according to the embodiment of the present invention. As shown in FIG. 1, FIG. 2, FIG. 7 and FIG. 8, the lock 30 further includes an unlocking member 33 slidably disposed inside the latch sleeve 32 and activated by an external force exerted on the handle device 60, so that the latch driving member 34 is driven to slide inside the latch sleeve 32. In other words, the latch driving member 34 is driven by the unlocking member 33 with rotation of the handle device 60, so as to be retracted inside the latch sleeve 32 in a first direction X for unlocking the door. Furthermore, a constraining structure 35 is further formed on the latch driving member 34 for constraining the unlocking member 33, so that the latch driving member 34 overlaps the unlocking member 33.

In this embodiment, the latch head 36 is made of stainless steel which has a higher melting point. When a special case, such as a fire, occurs, the latch head 36 of the present invention is capable of enduring high temperature without melting. Accordingly, the lock 30 of the present invention keeps functioning normally under the special case, so as to keep the fire within a specific area for stopping the spread of the fire. As a result, the people in the fire place can escape in time for decreasing a number of casualties.

It should be noticed that metal materials for the latch head 36 of the present invention are not limited to those mentioned in this embodiment. For example, the latch head 36 can be made of copper or steel materials. As for which one of the above-mentioned designs is adopted, it depends on practical demands. Practically, the latch head 36 is made in a powder forming manner, so that the fixing structures with complex structures, such as a through hole, a screw hole and so on, are achievable on the latch head 36. As mentioned above, a second fixing structure 361 can be formed on the latch head 36 and located in a position corresponding to the first fixing structure 341 on the latch driving member 34.

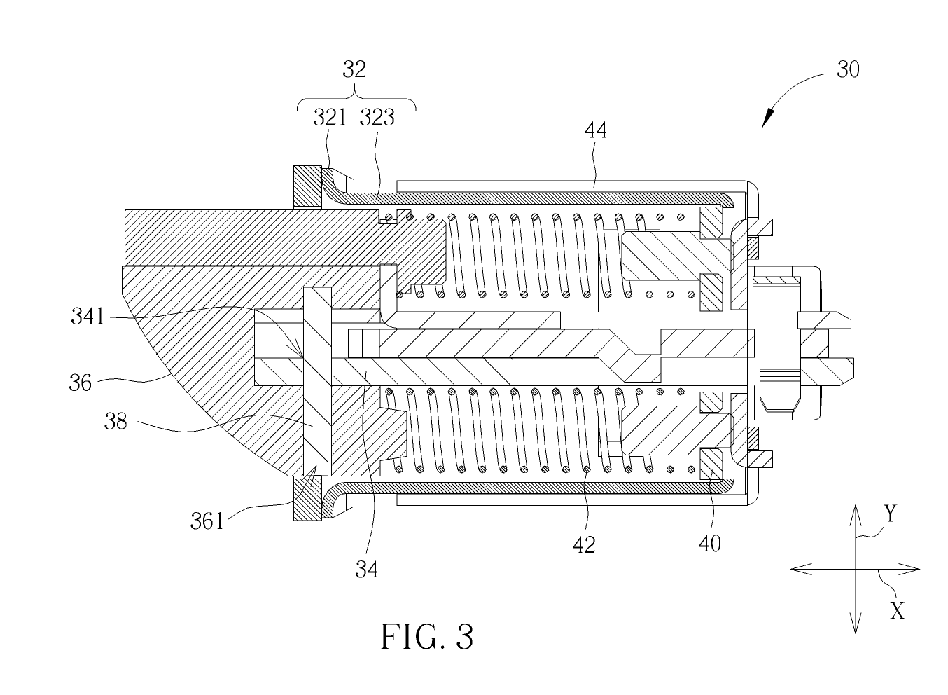

Please refer to FIG. 1 to FIG. 3. FIG. 3 is a sectional diagram of the lock 30 according to the embodiment of the present invention. As shown in FIG. 1 to FIG. 3, the lock 30 further includes a connecting structure 38 connected to the first fixing structure 341 and the second fixing structure 361. Accordingly, the connecting structure 38 can be used for fixing the latch head 36 on the end of the latch driving member 34. In this embodiment, the first fixing structure 341 on the latch driving member 34 and the second fixing structure 361 on the latch head 36 are respectively a through hole structure, and the connecting structure 38 is a pin. During assembly, the connecting structure 38, i.e. the pin, is inserted into the first fixing structure 341 on the latch driving member 34 and the second fixing structure 361 on the latch head 36, i.e. the two through hole structures, so as to fix the latch head 36 on the end of the latch driving member 34. In this embodiment, the two through hole structures, i.e. the first fixing structure 341 and the second fixing structure 361, are oriented in a second direction Y perpendicular to the first direction X.

As shown in FIG. 2, FIG. 3 and FIG. 7, the lock 30 further includes a base plate 40 and a resilient member 42. The base plate 40 is installed inside the latch sleeve 32, and both ends of the resilient member 42 abut against the base plate 40 and the latch head 36, respectively. When the handle device 60 is rotated to drive the latch driving member 34 for retracting the latch head 36 inside the latch sleeve 32, the latch head 36 compresses the resilient member 42. Meanwhile, the resilient member 42 stores a resilient potential energy. When the handle device 60 is released, the resilient member 42 releases the resilient potential energy for generating a resilient force. The resilient force drives the latch head 36 to stretch out of the latch sleeve 32, i.e. the latch head 36 is biased to stretch out of the latch sleeve 32 by the resilient member 42. In such a manner, the latch head 36 can lock the door.

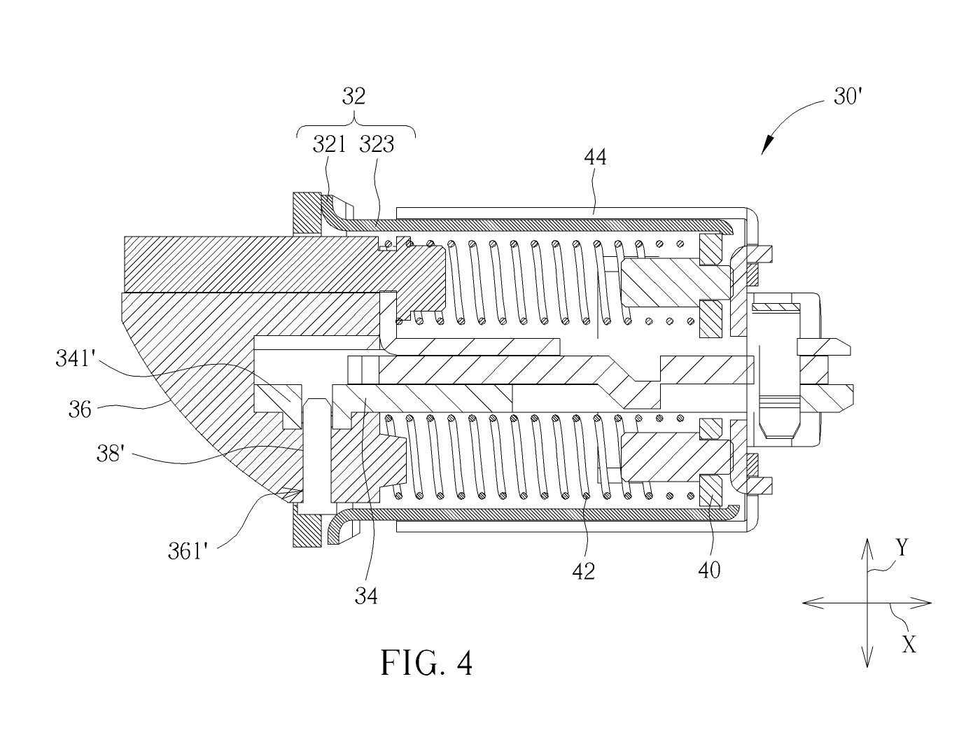

It should be noticed that structures for fixing the latch driving member 34 and the latch head 36 of the present invention are not limited to those mentioned in this embodiment. Please refer to FIG. 4. FIG. 4 is a sectional diagram of a lock 30′ according to another embodiment of the present invention. As shown in FIG. 4, the main difference between the lock 30′ and the aforesaid lock 30 is that a first fixing structure 341′ of the latch driving member 34 is a screw post, a second fixing structure 361′ of the latch head 36 is a through hole structure, and a connecting structure 38′ is a screw component. During assembly, the connecting structure 38′ (i.e. the screw component) is disposed through the second fixing structure 361′ (i.e. the through hole structure) of the latch head 36 for being screwed onto the first fixing structure 341′ (i.e. the screw post) of the latch driving member 34, so as to fix the latch head 36 on the end of the latch driving member 34. In this embodiment, both of the screw post (i.e. the first fixing structure 341′) and the through hole structure (i.e. the second fixing structure 361′) are oriented in a second direction Y perpendicular to the first direction X. Components in this embodiment with denotations identical to those in the aforesaid embodiment have identical structures and functions, and further description is omitted herein for simplicity.

As mentioned above, the present invention can utilize the first fixing structure 341, the second fixing structure 361 and the connecting structure 38 to fix the latch driving member 34 and the latch head 36 in a structural disposing manner. Alternatively, the present invention can utilize the first fixing structure 341′, the second fixing structure 361′ and the connecting structure 38′ in a screwing manner for fixing the latch driving member 34 and the latch head 36. As a result, the present invention can stably fix the latch driving member 34 and the latch head 36. Accordingly, it can prevent the latch driving member 34 from loosing from the latch head 36, so that the lock 30 of the present invention can function normally. As for which one of the above-mentioned designs is adopted, it depends on practical demands.

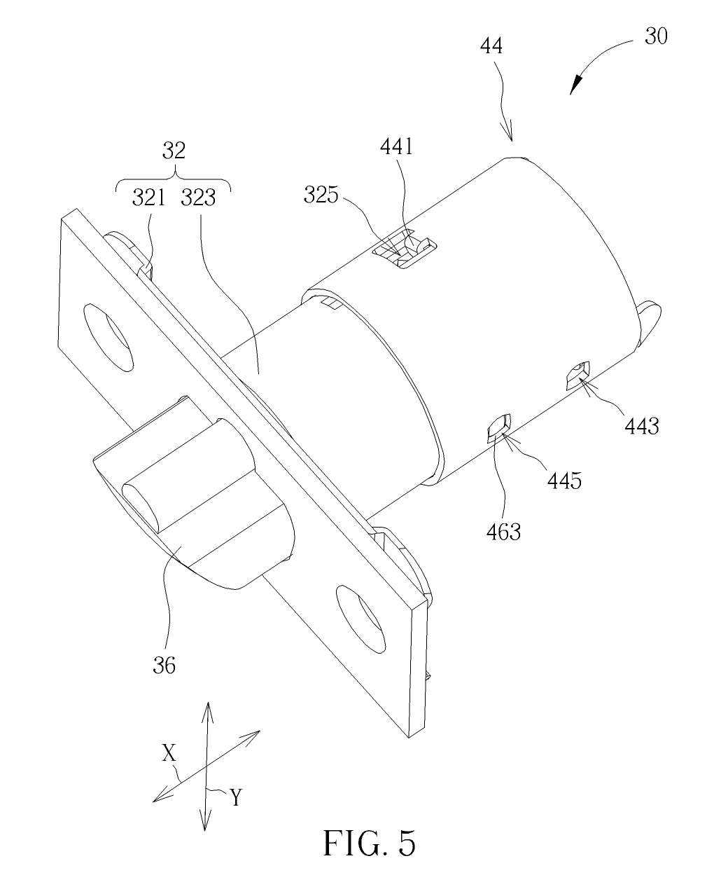

Please refer to FIG. 1 to FIG. 3, FIG. 5 and FIG. 7. FIG. 5 is a diagram of the lock 30 in another status according to the embodiment of the present invention. As shown in FIG. 1 to FIG. 3, FIG. 5 and FIG. 7, the latch sleeve 32 includes a fixing plate 321 and a sleeve body 323 connected to the fixing plate 321. The fixing plate 321 is used for fixing the sleeve body 323 onto the door. In addition, the lock 30 further includes an extending sleeve 44, and the unlocking member 33 protrudes from the extending sleeve 44. Furthermore, a first sliding structure 325 is formed on the sleeve body 323, and a second sliding structure 441 is formed on the extending sleeve 44. The first sliding structure 325 is used for cooperating with the second sliding structure 441, so that the extending sleeve 44 sheathes the sleeve body 323 in a slidable manner. In other words, the extending sleeve 44 is capable of sliding relative to the sleeve body 323, so as to adjust a distance between the extending sleeve 44 and the fixing plate 321. In other words, the lock 30 can adjust its length by sliding design of the extending sleeve 44 and the sleeve body 323 of the latch sleeve 32, so that the lock 30 can be installed with the handle device 60 in different positions. In other words, the lock 30 can be implemented to the doors with different specifications by the aforesaid sliding mechanism.

In this embodiment, the first sliding structure 325 is a sliding slot, and the second sliding structure 441 is a hook. The hook is movably engaged inside the sliding slot, so that the extending sleeve 44 slides relative to the sleeve body 323. In addition, when the hook movably engages with the sliding slot, the hook can constrain the extending sleeve 44 from rotating relative to the sleeve body 323. In other words, the hook can be further used for preventing the extending sleeve 44 from rotating relative to the sleeve body 323. Structures of the first sliding structure 325 and the second sliding structure 441 of the present invention are not limited to those mentioned in this embodiment. For example, the first sliding structure 325 and the second sliding structure 441 can be a combination of a sliding slot and a sliding protrusion as well. In other words, the structures enabling the extending sleeve 44 to movably sheathe the sleeve body 323 are within the scope of the present invention.

As shown in FIG. 1 to FIG. 3 and FIG. 5, a first constraining structure 443 and a second constraining structure 445 are formed on the extending sleeve 44. The lock 30 further includes a resilient engaging member 46 installed on the sleeve body 323. Furthermore, the resilient engaging member 46 includes a resilient body 461 and a protruding structure 463. The resilient body 461 resilient abuts against the sleeve body 323, and the protruding structure 463 is disposed on the resilient body 461. Due to sliding cooperation of the first sliding structure 325 and the second sliding structure 441, when the extending sleeve 44 slides relative to the sleeve body 323 to a position where the protruding structure 463 is aligned with the first constraining structure 443, the resilient body 461 provides a resilient force to the protruding structure 463, so that the protruding structure 463 is driven to engage with the first constraining structure 443 by the resilient body 461. Accordingly, the extending sleeve 44 can be fixed in a first position shown in FIG. 1 by the resilient engaging member 46. When the extending sleeve 44 slides relative to the sleeve body 323 to a position where the protruding structure 463 is aligned with the second constraining structure 445, the resilient body 461 provides the resilient force to the protruding structure 463, so that the protruding structure 463 is driven to engage with the second constraining structure 445 by the resilient body 461. Accordingly, the extending sleeve 44 can be fixed in a second position shown in FIG. 5 by the resilient engaging member 46.

A containing slot 327 is formed on the sleeve body 323, as shown in FIG. 2. In this embodiment, the resilient body 461 is a C-shaped structure, and the containing slot 327 is a C-shaped slot corresponding to the C-shaped structure. Structures of the resilient body 461 and the containing slot 327 are not limited to those mentioned in this embodiment. For example, the resilient body 461 can be a spring as well, and the containing slot 327 can be a long recess slot corresponding to the spring. In other words, the structures enabling the protruding structure 463 of the resilient engaging member 46 to engage with the first constraining structure 443 and the second constraining structure 445 of the extending sleeve 44 are within the scope of the present invention.

In summary, the extending sleeve 44 can utilize the resilient engaging member 46 to selectively engage with the first constraining structure 443 or the second constraining structure 445, so as to fix the extending sleeve 44 in the corresponding first position or the second position. Accordingly, the lock 30 is capable of adjusting its length for being installed onto the handle device 30 indifferent positions. In this embodiment, the first constraining structure 443 and the second constraining structure 445 are, but not limited to, respectively an opening structure. For example, the first constraining structure 443 and the second constraining structure 445 can be respectively an engaging slot as well, or conversely, the first constraining structure 443 and the second constraining structure 445 can be disposed on the sleeve body 323, and the resilient engaging member 46 is installed on the extending sleeve 44. In other words, the structures capable of fixing the extending sleeve 44 and the sleeve body 323 in different positions are within the scope of the present invention.

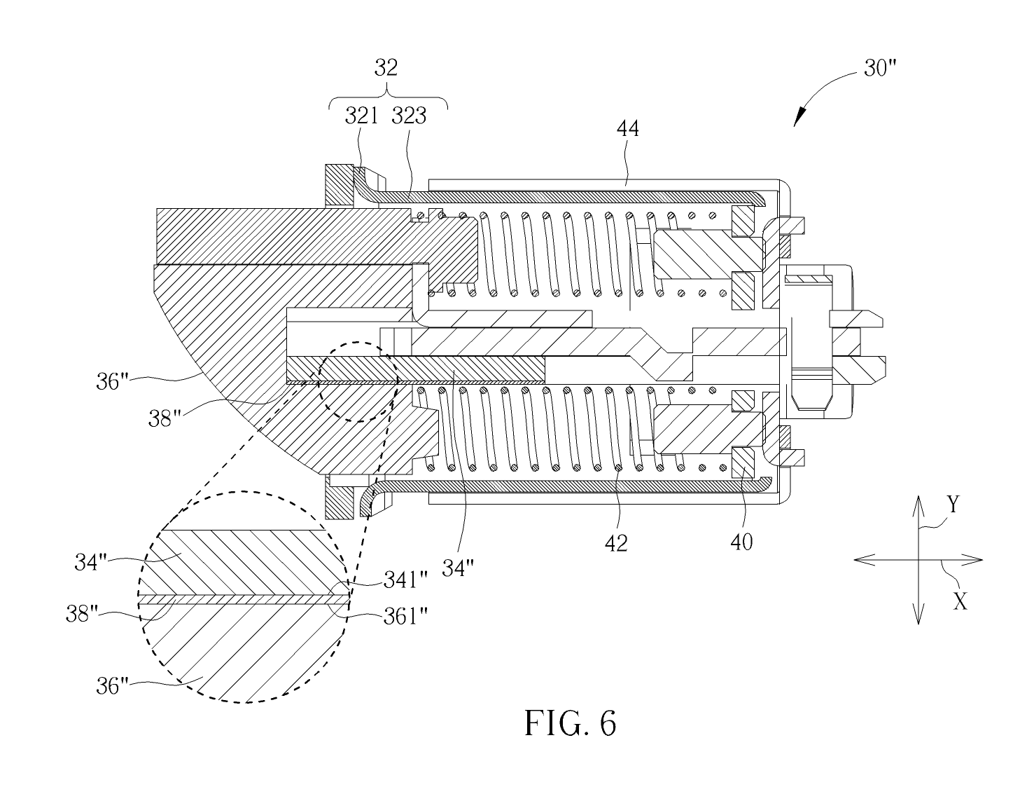

Please refer to FIG. 6. FIG. 6 is a sectional diagram of a lock 30″ according to another embodiment of the present invention. As shown in FIG. 6, the main difference between the lock 30″ and the aforesaid lock 30 is that a first fixing structure 341″ of a latch driving member 34″ and a second fixing structure 361″ of a latch head 36″ of the lock 30″ are respectively a surface structure, and a connecting structure 38″ connects the first fixing structure 341″ (i.e. the surface structure) and the second fixing structure 361″ (i.e. the surface structure) in a face-to-face manner. In this embodiment, the connecting structure 38″ is a welding structure for welding the first fixing structure 341″ of the latch driving member 34″ and the second fixing structure 361″ of the latch head 36″.

It should be noticed that the latch head 36″ is made of stainless steel which has a higher melting point. When a special case, such as a fire, occurs, the latch head 36″ of the present invention is capable of enduring high temperature without melting. Accordingly, the lock 30″ of the present invention keeps functioning normally under the special case, so as to keep the fire within a specific area for stopping the spread of the fire. As a result, the people in the fire place can escape in time for decreasing a number of casualties.

In addition, there is a design change implemented in the handle device 60 of the present invention in order to satisfy differences of fire prevention regulations performed from nation to nation. As shown in FIG. 7, the handle device 60 includes a handle body 601 and a pivoting portion 603. The pivoting portion 603 includes a surrounding wall 604 formed along a longitudinal axis L, and the surrounding wall 604 has a top surface 605 which is located on one end of the surrounding wall 604. The handle body 601 includes an extended portion 607. The extended portion 607 protrudes from the pivoting portion 603 along a radial direction D perpendicular to the longitudinal axis L. Furthermore, the extended portion 607 of the handle body 601 is not connected to the top surface 605 of the pivoting portion 603, i.e. the extended portion 607 of the handle body 601 is apart from the top surface 605 of the surrounding wall 604 by a gap G. The extended portion 607 is used for providing a user with a place to apply force, so that the handle body 601 is rotated to drive the latch for performing the unlocking or locking motion. A latch assembly, not shown in figures, is installed inside the surrounding wall 604 of the pivoting portion 603 for matching a key, so as to perform the locking motion for the lock.

When the handle device 60 is installed on the door, the gap G makes the extended portion 607 of the handle body 601 approach the door without shortening the pivoting portion 603, i.e. the pivoting portion 603 can keep original length and thus the design change for the latch assembly is not required. Furthermore, the handle body 601 is located nearby a center of the pivoting portion 603, resulting in mass concentration. As a result, it can avoid the mass from aggregating on an end of the pivoting portion 603 and further increase feasibility of the handle device 60.

In other words, the present invention can change a distance between the extended portion 607 of the handle body 601 and the door by adjusting the gap G, so as to satisfy the fire prevention regulations from nation to nation and further to increase flexibility in use. In addition, since the size of the pivoting portion 603 does not change, there is no need to do design change on the latch assembly for saving costs. In other words, the structural design of the extended portion 607 of the handle body 601, the pivoting portion 603 and the gap G of the present invention can not only satisfy the fire prevention regulations from nation to nation but also save costs.

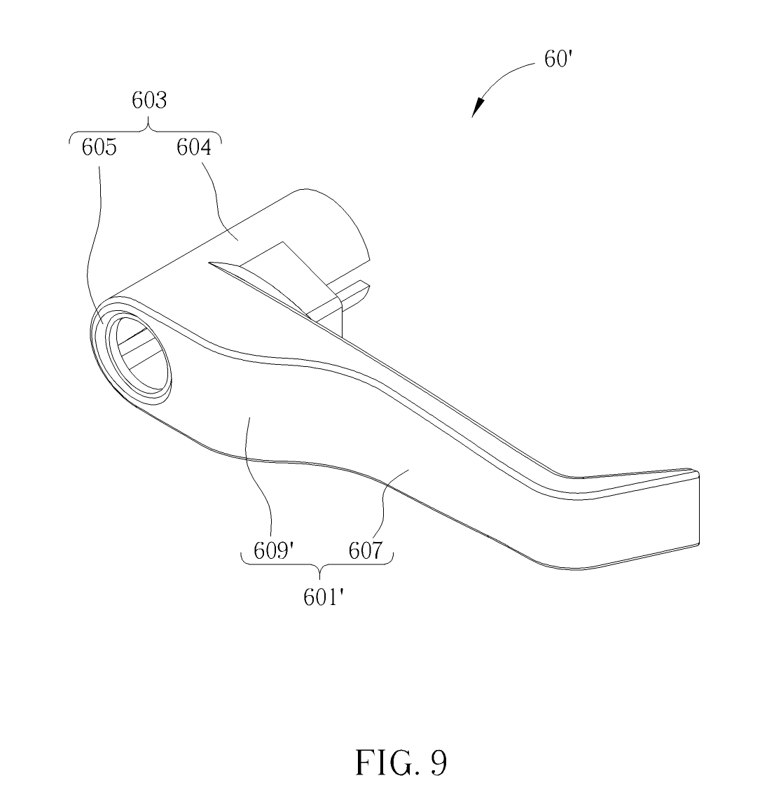

As shown in FIG. 7 and FIG. 8, the handle body 601 further includes a neck portion 609 connected to the top surface 605 of the surrounding wall 604 and the extended portion 607. In this embodiment, the neck portion 609 is connected to the top surface 605 and the extended portion 607 in a curved manner for enhancing aesthetic feeling of appearance. Shape designs of the neck portion 609 are not limited to those mentioned in figures in this embodiment. For example, please refer to FIG. 9, which is a diagram of a handle device 60′ according to another embodiment of the present invention. As shown in FIG. 9, the main difference between the handle device 60′ and the aforesaid handle device 60 is that the curvature of a neck portion 609′ of a handle body 601′ of the handle device 60′ is different from the curvature of the neck portion 609 of the handle body 601 of the handle device 60. Components in this embodiment with denotations identical to those in the aforesaid embodiment have identical structures and functions, and further description is omitted herein for simplicity.

Compared to the prior art, the latch head of the lock of the present invention is made of metals which has a higher melting point, such as stainless steel, copper, steel and so on. When a special case, such as a fire, occurs, the latch head of the present invention is capable of enduring high temperature without melting. Accordingly, the lock of the present invention keeps functioning normally under the special case, so as to keep the fire within a specific area for stopping the spread of the fire. As a result, the people in the fire place can escape in time for decreasing a number of casualties. Practically, the latch head of the lock of the present invention is made in a powder forming manner, so that the fixing structures with complex structures, such as a through hole, a screw hole and so on, are achievable on the latch head. The fixing structures can cooperate with a fixing member, such as a pin, a screw component and so on, for fixing the latch head and the latch driving member. Alternatively, the latch head and the latch driving member of the present invention can be fixed by welding. Accordingly, the present invention utilizes the connecting structure to be disposed through or to weld for fixing the latch head and the latch driving member more stably, so as to prevent the latch head from loosing from the latch driving member and further to keep the lock function normally.

In addition, the present invention can further change a distance between the extended portion of the handle body and the door by adjusting the gap, so as to satisfy the fire prevention regulations from nation to nation and further to increase flexibility in use. In addition, since the size of the pivoting portion does not change, there is no need to do design change on the latch assembly for saving costs. In other words, the structural design of the extended portion of the handle body, the pivoting portion and the gap of the present invention can not only satisfy the fire prevention regulations from nation to nation but also save costs.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A handle device, comprising:
a pivoting portion comprising a surrounding wall formed along a longitudinal axis, the surrounding wall having a top surface; and
a handle body comprising an extended portion which protrudes from the pivoting portion along a radial direction perpendicular to the longitudinal axis and is apart from the top surface of the surrounding wall by a gap.

2. The handle device of claim 1, wherein the extended portion of the handle body is not connected to the top surface of the surrounding wall.

3. The handle device of claim 1, wherein the handle body further comprises:
a neck portion connected to the top surface of the surrounding wall and the extended portion in a curved manner.

4. A lock, comprising:
a latch sleeve;
a latch head disposed inside the latch sleeve in a retractable manner; and
a handle device for retracting the latch head inside the latch sleeve, comprising:
a pivoting portion comprising a surrounding wall formed along a longitudinal axis, the surrounding wall having a top surface; and
a handle body comprising an extended portion which protrudes from the pivoting portion along a radial direction perpendicular to the longitudinal axis and is apart from the top surface of the surrounding wall by a gap.

5. The lock of claim 4, further comprising:
a latch driving member slidably disposed inside the latch sleeve, a first fixing structure being formed on an end of the latch driving member wherein the latch head is connected to the end of the latch driving member, the latch head retracting inside the latch sleeve in a first direction, a second fixing structure being formed on the latch head and located in a position corresponding to the first fixing structure; and
a connecting structure connected to the first fixing structure and the second fixing structure, the connecting structure being for fixing the latch head on the end of the latch driving member, so that the latch driving member drives the latch head to stretch out of the latch sleeve or retract inside the latch sleeve.

6. The lock of claim 5, wherein the first fixing structure and the second fixing structure are respectively a surface structure defined in the first direction, and the connecting structure connecting the first fixing structure and the second fixing structure in a face-to-face manner.

7. The lock of claim 5, wherein the first fixing structure and the second fixing structure are respectively a through hole structure oriented in a second direction perpendicular to the first direction, and the connecting structure is inserted into the two through hole structure.

8. The lock of claim 5, wherein the first fixing structure is a screw post, the second fixing structure is a through hole structure, the screw post and the through hole structure are oriented in a second direction perpendicular to the first direction, and the connecting structure is disposed through the through hole structure for being screwed onto the screw post, so as to fix the latch head on the end of the latch driving member.

9. The lock of claim 5, further comprising:
an unlocking member slidably disposed inside the latch sleeve and activated by an external force exerted on the handle device, the latch driving member being driven by the unlocking member, a constraining structure being formed on the latch driving member for constraining the unlocking member, so that the latch driving member overlaps the unlocking member.

10. The lock of claim 9, wherein the latch sleeve comprises a fixing plate and a sleeve body connected to the fixing plate, the fixing plate is for fixing the sleeve body onto a door, and the lock further comprises:
an extending sleeve slidably sheathing the sleeve body, the unlocking member protruding from the extending sleeve.

11. The lock of claim 10, wherein a first sliding structure is formed on the sleeve body, a second sliding structure is formed on the extending sleeve, and the first sliding member cooperates with the second sliding member for sliding the extending sleeve relative to the sleeve body.

12. The lock of claim 10, wherein a first constraining structure and a second constraining structure are formed on the extending sleeve, the lock further comprises a resilient engaging member installed on the sleeve body, and the resilient engaging member comprises:
a resilient body resiliently abutting against the sleeve body; and
a protruding structure disposed on the resilient body, the protruding structure being driven by the resilient body when the extending sleeve slides relative to the sleeve body to a position where the protruding structure is aligned with the first constraining structure, so as to engage with the first constraining structure, the protruding structure being further driven by the resilient body when the extending sleeve slides relative to the sleeve body to a position where the protruding structure is aligned with the second constraining structure, so as to engage with the second constraining structure.

13. The lock of claim 4, wherein the extended portion of the handle body is not connected to the top surface of the surrounding wall.

14. The lock of claim 4, wherein the handle body further comprises:
a neck portion connected to the top surface of the surrounding wall and the extended portion in a curved manner.
